(19) United States
(12) Patent Application Publication
(10) Pub. No.: US 2007/0005216 A1
(43) Pub. Date: Jan. 4, 2007

(54) Method and device for measuring a fluid pressure by means of a regulating device

(75) Inventors: Micha Heinz, Darmstadt (DE); Wolfgang Joeckel, Obertshausen (DE); Peter Oehler, Frankfurt/Main (DE); Axel Schmitz, Hattersheim (DE); Wolfgang Fey, Niedernhausen (DE); Mario Engelmann, Steinbach/Ts. (DE)

Correspondence Address: CONTINENTAL TEVES, INC., ONE CONTINENTAL DRIVE, AUBURN HILLLS, MI, 48326-1581, US

(73) Assignee: Continental Teves AG &Co. oHG

(21) Appl. No.: 10/566,527

(22) PCT Filed: Jul. 28, 2004
(86) PCT No.: PCT/EP04/51638

§ 371 Date: Aug. 28, 2006

(30) Foreign Application Priority Data
Jul. 31, 2003 (DE) 103 35 586.3
Nov. 26, 2003 (DE) 103 55 836.5

(51) Int. Cl. B60T 7/12; G05D 1/00

(52) U.S. Cl. 701/78

(57) ABSTRACT

A method and device for determining the pressure of a fluid or the differential pressure prevailing at an actuator use an electromagnetically drivable actuator (4) for pressure measurement. For example, an electric control circuit is used to control the position of a valve actuating device or the force which acts on a valve actuating element.

### BACKGROUND OF THE INVENTION

The present invention relates to a method for measuring the pressure in a fluid or a pressure differential at an actuator.

In EP 1 282 544 A1 it is disclosed to employ pressure sensors to measure the hydraulic pressure in the wheel brakes in ABS control units for motor vehicle brake systems but also in so-called driving dynamics controllers equipped with additional functions such as ESP, etc., the above pressure sensors including a metering diaphragm, from the deformation of which the prevailing differential pressure can be concluded.

The additional provision of pressure sensors in a large-scale integrated electronic brake control unit has an undesirably great influence on the mounting space required and the manufacturing costs of the control unit.

### SUMMARY OF THE INVENTION

It has been found that the above-mentioned drawbacks can be overcome by using an actor applicable for the regulation or control of the hydraulic pressure, which is a hydraulic valve in particular, for pressure measurement.

Using an actor as a pressure sensor is rendered possible because the magnetic part of the arrangement which actuates the mechanical part of the actor is subjected to a control circuit which controls, in particular, the force that acts on the mechanical part. Pressure measurement can this way be performed using an actuator without additional pressure sensors.

The term ‘actuators’ relates to valves and slides for the adjustment of fluid flow. Preferably, the actuator used is a valve. The fluid preferred beside air is also any appropriate hydraulic fluid which is in particular a customary brake fluid in the application with a brake.

Favorably, the actuator has a completely opened and a completely closed position. Depending on the type of actuator, normally open (NO-V) or normally closed (NC-V), the valve actuating device (e.g. the valve tappet) adopts one of these positions, in response to the action of a resetting element. An appropriate resetting element is preferred to be a spring which has a defined force/travel characteristic curve that can be approximated especially by a linear equation according to the method. As will be described hereinbelow, the opening stroke of the actuator (position of the valve actuating device) can be calculated from the measurable magnetic force in the case of a balance of forces at the valve actuating element.

The actuator comprises an electromagnetic arrangement in which a mechanical actuating element is movable by means of the actuation of an exciter coil. The actuating element described preferably concerns an axially displaceable, magnetizable armature which can be moved by the magnetic field of the exciter coil. More particularly, this armature is disposed inside a valve dome.

The magnetic force or the opening stroke of the actuator being controlled according to the method of the invention can favorably be determined from the induced voltage integrated thereto. As has been mentioned already, the magnetic force can be computed in the opening stroke by applying the known force/travel equation for the resetting element, provided the force/travel interrelationship is known.

In the magnetic circuit the actuator is preferably furnished with one or more additional measuring elements to determine the magnetic flux, with the additional measuring element being a measuring coil in particular.

So-called analogized pilot valves are used in up-to-date generations of hydraulic control units. An analogized pilot valve which is favorably employed in the method of the invention is a current-driven solenoid valve which is not only designed for complete opening or closing, however, is so operated by specific current adjustment and its constructive design that it has analog control properties.

The method of the invention is favorably employed in an electrohydraulic device for brake control for motor vehicles.

It is advantageous for a precise pressure measurement that the opening stroke of the actuator is adjusted to a predetermined value. For this purpose, the corresponding exciting current in the unpressurized condition must be known first. It should be noted in this respect that depending on the respective actuator in a line of products, there will be significant deviations, what does not make it easy to adjust the desired current with the rate of precision needed. It is therefore appropriate to use e.g. individual characteristic curves for the valve in conformity with the method, rendering it possible to compensate for at least tolerances of mechanics, such as changing spring forces F_{spring} and different magnetic resistances of the air slots.

To this end, it is possible to use an existing characteristic curve or a characteristic curve (pressureless calibration) which is determinable according to the following method. In lieu of characteristic curves, parameters or characteristic fields can also be used which are stored in an arithmetic unit in particular. To determine the characteristic curve, advantageously, the routine referred to as pressureless calibration in the following is preferably performed, where one or more actuator-related characteristic curves, characteristic fields or parameters KG_{ind} for the actuator are established so that by means of these parameters the interrelationship between flow G, current intensity I in the exciter coil, and the prevailing pressure difference ΔP is defined.

The calibration operation is executed preferably by considering the opening travel 1 and/or the spring force F_{spring} and/or the magnetic resistance of the actuator.

Advantageously, individual magnetic and mechanical parameters KG_{ind} of the actuator are taken into account in the measuring routine, which are mainly responsible for the manufacture-induced deviation in the respective characteristic curve. The parameters of the actuator which are less subjected to deviations due to manufacture can be fixed once for the line of products by additional general parameters KG_{gen} and can be stored durably in the electronic control unit. The actuator characteristic curve and, thus, the necessary drive current, being responsive to the differential pressure, for the actuator can then be calculated from the individual and general parameters.

According to a favorable embodiment of the calibration method, the total magnetic resistance of the magnetic circuit is measured. It applies in general that instead of the magnetic resistance, it is also possible to use the inductance L of the corresponding magnetic circuit, related to the number of windings N of the coil, as an equivalent physical quantity in a corresponding manner for implementing the method of the invention. In particular the magnetic resistance in the completely opened and/or completely closed actuator position is determined. In an especially preferred fashion, the maximum tappet stroke and/or the spring force are determined in the calibration.

Preferably, the actuator comprises one or more additional measuring elements, in particular measuring coils. The measuring coil can be connected electrically independently of the drive coil. It is, however, possible according to a preferred embodiment to connect the measuring coil electrically in series with the drive coil. This is advantageous because only three actuating lines must be led to the outside.

It is feasible by means of a measuring element which is arranged in the area of the actuator according to another embodiment of the invention, to determine internal physical parameters of the actuator and to take them into account when calculating the pressure.

Preferably, all magnetic-field-responsive sensors (such as Hall sensors, MR sensors) can principally be used as a measuring element beside the coil, provided they are suitable to sense the effective magnetic flux. The use of a coil appears, however, especially expedient due to the possibility of its low-cost manufacture.

The so-called holding currents which are determined on the basis of the balance equation F_{spring}+F_{hydraulics}=F_{magn} at a defined pressure difference do not yet correspond to the opening currents actually required to open the valve with a sufficient rate of precision, as the opening currents are always somewhat lower than the calculated holding currents, which is due to flow effects. It has shown that the more accurate opening current characteristic curve I_{opening}(ΔP) can preferably be determined in that a constant negative current offset I_{corr}^{const} is added in the required pressure difference range of the holding current characteristic curve I_{holding}(ΔP). According to a preferred embodiment of the calibration method, the valve opening current of the valve rather than the holding current is therefore made the basis. To this end, especially the valve opening current is corrected by a correction term which is a constant current offset in the simplest case. Apart from this so-called opening current correction, it is furthermore possible and preferred to arrange for another correction term which also takes into consideration the current-responsive influence of the ferromagnetic circuit. Apart from the magnetic correction described before, it may be suitable to perform a thermal correction in consideration of the ohmic exciter coil resistance.

The exciter coil which drives the actuator is actuated preferably by means of a pulse-width modulated current (PWM), and the coil resistance is determined especially by way of the duty cycle of the PWM actuation. It is especially preferred that the coil resistance is taken into account in the calculation of the parameters KGind in each individual actuator in order to enhance the accuracy.

It is preferred according to the method that the integral of the induced voltage in the magnetic circuit of the actuator is defined to determine the magnetic flux or the magnetic force. According to another independent embodiment of the method of the invention, the measurement of the integral at the coil tap or at the tap of the measuring coil, respectively, is performed by means of a so-called electronic square-wave forming circuit which has a particularly straightforward design. This method concerns determining the magnetic flux in at least one inductive actuator, which can be actuated electrically by means of a driver, by way of evaluation or adjustment of the voltage U_{ind} induced at the exciter coil of the actuator by using an electronic measuring device, and the voltage applied to the coil is maintained at a substantially constant value actively by the measuring device or by the electronic actuation of the inductive actuator or actor component, and the time t₁ is determined during which the current flowing through the inductive component and the measuring device induces a voltage when enabled or disabled.

Further preferred embodiments can be seen in the subsequent description of embodiments by way of Figures.

### BRIEF DESCRIPTION OF THE DRAWINGS

In the drawings:

FIG. 1 is a schematic view of the hydraulic components of a pressure control valve;

FIG. 2 is a basic circuit diagram of a control circuit for adjusting a constant tappet position;

FIG. 3 is a sketch explaining the principal geometric shape at the narrowest point in the valve, and;

FIG. 4 shows a schematic view of a motor vehicle brake control unit.

### DETAILED DESCRIPTION OF THE DRAWINGS

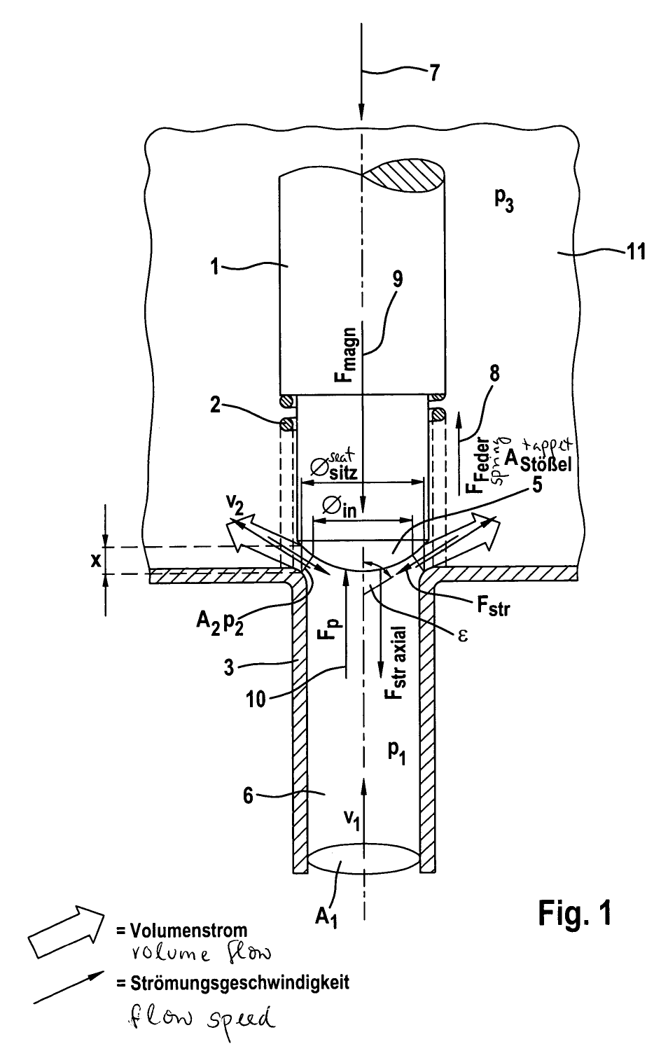

In FIG. 1, valve tappet 1 is moved axially in the direction of the arrow 7 by an electromagnetic arrangement (not shown) so that the tappet surface 5 is inserted into valve seat 3 for sealing purposes. The force of spring 2, being seated on valve seat 3, acts on valve tappet 1 in the direction of arrow 8 (F_{spring}). The electromagnetic arrangement produces a force component F_{magn} in the direction of the arrow 9. Pressure which is referred to as p₃ prevails in the range of the brake circuit that leads to the wheel brake cylinder. Pressure p₁ prevails in a pressure-generating master cylinder (not shown) of the brake system. Arrow 10 indicates the direction of effect of the hydraulic force Fₚ which acts on tappet 1.

The schematic illustration in FIG. 1 serves to explain the coefficients of influence taken into account in the assessment of the hydraulic force. The forces acting on the valve tappet are, on the one hand, the flow force F_{flow} which is achieved due to the high speed in the narrowest cross-section A₂ and the resulting vacuum p₂ causing closure of the valve in the direction of F_{flow axial} and, on the other hand, the pressure force Fₚ which is produced because the fluid presses on the tappet, what causes the valve to open (if p₁≧p₃ applies). The conventional formula derived from the Bernoulli equation applies for the flow force:

$$Q = {α}_{D} {A}_{2} \sqrt{2 \frac{( Δ p )}{ρ}} ,$$

where Q is the volume flow, A₂ is the flow surface in the narrowest cross-section, α_{D} is the coefficient of flow, Δp=p₁−p₃ is the differential pressure, and ρ relates to the density of the brake fluid.

It shall be assumed for simplification that the coefficient of flow α_{D}≈[0.58 . . . 0.7] is relatively constant compared to the opening stroke x.

When neglecting the unsteady part of the flow force, the latter can be indicated as:
F_{Str}=ρv₂Q
where v₂ is the flow speed at the narrowest point. Further, Q=A₂v₂ applies. From this results the flow force according to
F_{Str}=2A₂α_{D}²ΔP

Only the axial component of this force acts on the tappet. By way of ε, the angle between the valve axis and the flow in the area of the narrowest cross-section, the axially acting flow force can be defined:
F_{Str}_{_{—}}ₐₓᵢₐₗ=F_{Str} cos ε

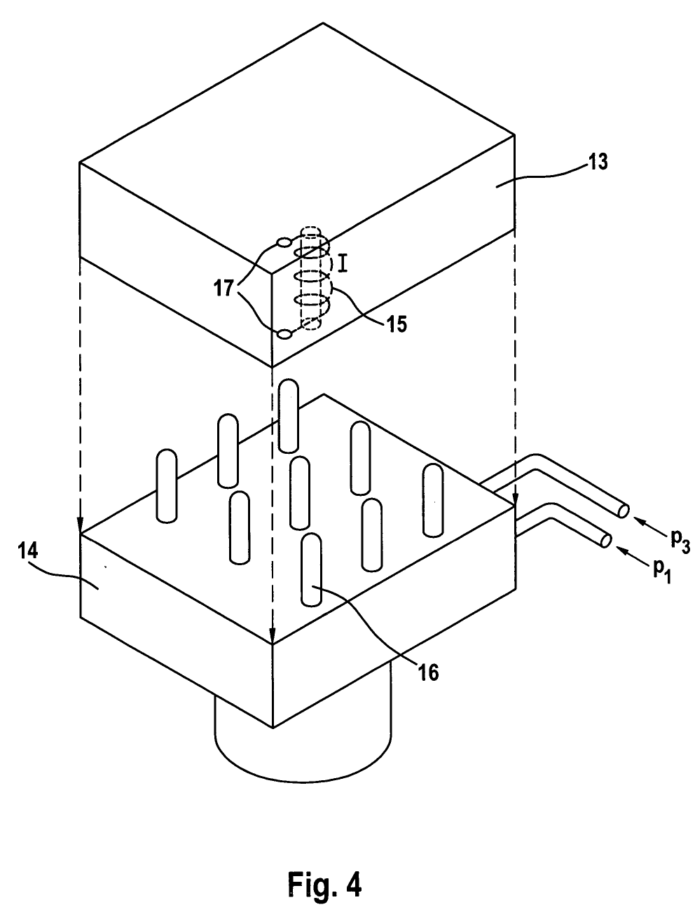

The surface of the so-called stroke diaphragm at the narrowest point can be defined quite accurately by way of the peripheral surface of a straight truncated cone, as is outlined like a model in FIG. 3. The following interrelationship will apply:

$${A}_{2} = l * \prod \frac{{∅}_{sitz} + {∅}_{in}}{2} ,$$

where l=x sin ε.

Due to the fluid flowing through the opened valve, an additional force of pressure F_{P} develops which is opposed to the flow force F_{flow} in the case P₃<P₁ in terms of the sense of force, however, acts in the identical sense of force in the case P₃>P₁.

The force of pressure is proportional to the differential pressure:
F_{P}=α_{acorr}*A₁*Δp

The correction factor αₖₒᵣᵣ≦1 shall express that the pressure decreases towards the edge of the tappet.

The spring force can be described by the formula
F_{spring}=D*x.

The following differential equation for the movement of the tappet results from the above-mentioned balance of forces at the tappet:
F_{P}−F_{Str}_{_{—}}ₐₓᵢₐₗ=F_{magn}−F_{spring}+mₜₐₚₚₑₜ₊ₐᵣₘₐₜᵤᵣₑ\ddot{x}

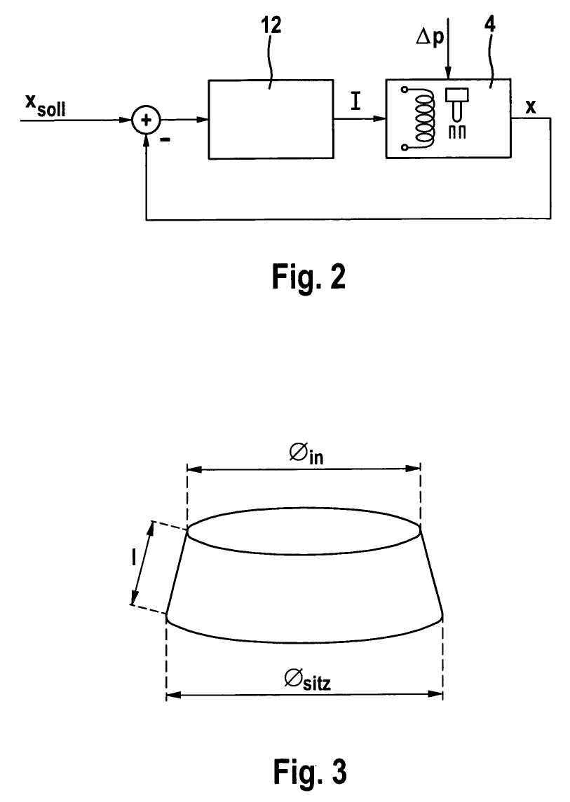

FIG. 2 illustrates a possible circuit configuration for the tappet stroke control according to the invention. Xₙₒₘᵢₙₐₗ refers to the nominal value for the tappet position. The starting value Xₙₒₘᵢₙₐₗ is defined by a parameter stored in the memory of the controller. Controller 12 maintains the tappet stroke x constant.

Hence, the acceleration is zero. The differential equation can be resolved in terms of the magnetic force, and the individual forces can be employed correspondingly:

$${F}_{magn} = {α}_{korr} {A}_{1} Δ p - \prod x sin ɛ \frac{{∅}_{sitz} + {∅}_{in}}{2} {α}_{D}^{2} 2 Δ p cos ɛ + Dx$$

This equation can also be formulated more simply by using the constants a and b:
F_{magn}=a*Δp+b,

In this arrangement, the constants a and b depend only on the geometry, the spring constant, and the constantly adjusted tappet position.

The relation between magnetic force and magnetic flux allows defining the magnetic flux:
Φ=\sqrt{2μ₀A_{An ker}(a*Δp+b)}

The accuracy in pressure determination can be enhanced still further corresponding to the alternative method of calculation that will be described in the following.

Thus, the pressure difference across the valve can be qualitatively determined by means of the subsequently described measurement of the magnetic flux by way of the integral of the induced voltage.

It should be noted in addition that it appears suitable for the calculation of an accurate quantitative interrelationship to still take into account the coefficients of influence mentioned hereinbelow:
The cross-section A₁ designated in FIG. 1 can be comprehended as a first flow diaphragm so that it is rendered possible to describe the model as a series arrangement of two diaphragms. An averaged throughflow may then be calculated based on this model.
The pressure decline of the said first diaphragm A₁ can be taken into account in the calculation of a correction term for a pressure decline.

It seems suitable for the further description of the invention to indicate the following mathematical interrelationships:

The magnetic force is achieved from

$${F}_{magn} = \frac{1}{2 * {μ}_{0} * {A}_{armature}} * {Φ}^{2} ,$$

where μ₀ is the permeability constant (air), Aₐᵣₘₐₜᵤᵣₑ is the armature surface, and Φ is the magnetic flux.

The magnetic flux is calculated according to the formula

$$Φ = \frac{Θ}{{R}_{m , total}}$$

$$with$$

$$Θ = I * N ,$$

where I is the coil current, N is the number of windings of the valve coil, and Rₘ^{total} is the total magnetic resistance of the magnetic circuit in the valve.

$${U}_{ind} = - N * \frac{ⅆ Φ}{ⅆ t}$$

$$and$$

$$Φ = - \frac{1}{N} {\int }_{o}^{t} {U}_{ind} ⅆ t$$

further applies.

FIG. 4 represents an electrohydraulic control unit for passenger car brakes comprising controller housing 13 (ECU) with a microcontroller system and a valve block 14 (HCU) connected thereto. In the assembly of the control unit the exciter coils 15 are slipped over the valve domes 16 containing the valves that have been described in connection with FIG. 1. The controller further comprises a control circuit which is used to adjust and also measure the current I of the individual exciter coils in a pulse-width-modulated fashion individually for each valve. To this end, controller 13 comprises for each valve individually actuatable PWM drivers. Measuring devices (not shown) are provided at the terminals 17 of the exciter coils and used to measure the induction voltage U_{ind}(t).

When the exciting current is disabled, the result is a change of the magnetic flux Φ in valve coil 15 which can be measured by way of the variation of the induction voltage U_{ind} at the coil. To this end, the integral with respect to time of the variation of the induced voltage U_{ind} is formed in a measuring device (not shown) and sent to the microcontroller of controller 13. This signal is proportional to the magnetic flux Φ induced by the valve coil, from which the pressure can be calculated according to the formula indicated above.

The above explanations relate to a valve which is normally open. The described method can be implemented similarly also for valves which are normally closed.

1-10. (canceled)

11. A method of determining a differential pressure of a fluid by utilizing an electromagnetically drivable actuator (4) for pressure measurement, which actuator comprises an electromagnetic arrangement, in which a mechanical actuating element is movable by means of actuation of an exciter coil, and a valve actuating device for opening and closing the actuator, the method comprising the following steps:
exerting a mechanical force with the actuating element for opening and/or closing the actuator on the valve actuating device (1),
controlling the position of the valve actuating device or the magnetic force by means of an electric control circuit, and
measuring the hydraulic force acting on the valve actuating device.

12. The method as claimed in claim 11,
wherein the hydraulic force acting on the valve actuating device is measured electrically by measuring the magnetic force that acts on the actuating element,

13. The method as claimed in claim 12,
wherein the magnetic force is determined from magnetic flux.

14. The method as claimed in claim 11,
including the step of opening or closing a passage between the closing element and a valve seat (3) by means of a resetting element (2) when the exciter coil is not excited.

15. The method as claimed in claim 11, including the following steps:
determining at least one characteristic quantity included in the following groups: individual parameters, characteristic curves, and characteristic fields; and
determining a current, under consideration of at least one of these quantities, to position the valve actuating device.

16. The method as claimed in claim 15,
wherein the at least one characteristic quantity is determined by a calibration routine measuring the actuator in atmospheric pressure.

17. The method as claimed in claim 16,
wherein the calibration routine is performed in the completely opened and/or completely closed position of the actuator.

18. The method as claimed in claim 15,
wherein, for the determination of the at least one characteristic quantity, at least one of the following characteristics of the actuator is determined: opening travel, spring force F_{spring}, magnetic resistance of the actuator.

19. The method as claimed in claim 15,
wherein the actuator is mounted in a system, the method taking into account general parameters KG_{gen} related to the system in addition to actuator-related parameters KG_{ind} which are established in a measuring routine.

20. The method as claimed in claim 15,
wherein a current variation is applied to the exciter coil and the induced voltage is measured as a characteristic quantity.

21. An electrohydraulic pressure control device including at least one electromagnetically operated actuator with an actuating element and a valve actuating device for controlling pressure,
wherein the electrohydraulic pressure control device is capable of exerting a mechanical force on the actuating element for opening and/or closing the valve actuating device,
controlling the position of the actuating element or the magnetic force by means of an electric control circuit,
measuring the hydraulic force acting on the valve actuating device.
